(19) United States
(12) Patent Application Publication
(10) Pub. No.: US 2017/0261009 A1
(43) Pub. Date: Sep. 14, 2017

(54) HYDRAULIC CONTROL DEVICE

(71) Applicant: LEMKEN GMBH & CO KG, Alpen (DE)

(72) Inventors: Georg PAULESSEN, Viersen (DE); Clemens DIEPERS, Aldekerk (DE); Dennis EIRMBTER, Willich (DE)

(21) Appl. No.: 15/510,239

(22) PCT Filed: Sep. 4, 2015
(86) PCT No.: PCT/DE2015/100381

§ 371 Date: Mar. 10, 2017

(30) Foreign Application Priority Data
Sep. 12, 2014 (DE) 10 2014 113 223.8

(51) Int. Cl. F15B 11/16; F15B 13/07; A01B 76/00; A01B 63/32; A01B 63/10; F15B 11/00; A01B 63/22

(52) U.S. Cl. CPC F15B 11/16; F15B 11/003; F15B 13/07; A01B 63/22; A01B 63/32; A01B 63/10; A01B 76/00; F15B 2211/30505; F15B 2211/7053; F15B 2211/71; F15B 2211/765; F15B 2211/20546

(57) ABSTRACT

The invention relates to a hydraulic positioning device for an agricultural implement, wherein preferably a uniform movement of several hydraulic cylinders is achieved by using a progressive distributor.

The invention relates to a hydraulic positioning device according to the preamble of claim 1.

A large number of different agricultural devices are known which perform positioning or folding functions via hydraulic cylinders. Such a device is, for example, presented in German patent application DE 2 537 391 A1. A tractor pulling the device provides the hydraulic pressure supply for the device. Sliding valves which are arranged on the tractor side or the device side lead the fluid flow from the pressure supply into or back from the individual hydraulic cylinders. For example, in order to adjust or fold a right-hand and left-hand half of the device synchronizedly, flow dividers are provided to supply the hydraulic cylinders with the same amounts of fluid and bring about an approximate synchronization of the hydraulic cylinders. However, the flow-based flow dividers shown here are subject to leakage inaccuracy. This inaccuracy may be countered, for example, by means of a gear-wheel flow divider which is, however, considerably more expensive to achieve.

For certain synchronization applications, master-slave circuits with hydraulic cylinders are also known, wherein a first double-acting hydraulic cylinder is pressurized on the piston crown side. The fluid volume displaced on the piston ring side actuates a second hydraulic cylinder, which is correspondingly smaller in size. If the piston crown side surface of the second cylinder corresponds to the piston-ring side surface of the first cylinder, synchronized movement of the cylinders is achieved. For this purpose, however, different cylinder sizes must be provided in one device, wherein the cylinders may only produce different actuating forces. The European patent application EP 2 286 649 A2 provides a soil working device with a master-slave circuit.

Progressive distributors are known in the professional world in another context, namely the forced distribution of lubricating grease. The publication EP 224 774 A2 describes such a distributor, as does U.S. Pat. No. 4,105,094 but with an alternative design.

WO 2004/051136 A1 discloses a progressive distributor with a displaceable piston, from whose outlets different lubricant volumes may be dispensed at a structurally low cost.

The object of the present invention is to provide a cost-effective and compact positioning device for the parallel and approximately synchronized actuation of several hydraulic cylinders, which is particularly suitable for small adjusting movements.

This object is achieved by the features of the characterizing part of claim 1. By using a progressive distributor which is known as a series product for lubricant metering and distribution, it is surprisingly simple to provide a hydraulic circuit for uniformly controlling and adjusting several hydraulic cylinders. Due to the sequence control circuit integrated in the progressive distributor, small distribution pistons successively dispense small amounts of fluid into the respective hydraulic cylinders. These cylinders successively change their cylinder stroke in small increments, wherein the theoretical stroke deviation of the hydraulic cylinders connected to the progressive distributor corresponds to the displacement volume of a single distribution piston of the progressive distributor to provide sufficient adjustment precision in the millimeter range as is usually the case with actuators in agricultural equipment.

By connecting at least two connections of the distribution device to one another and with a hydraulic cylinder in a parallel circuit, the fluid volume displaced by a plurality of distribution pistons may be combined in a hydraulic cylinder. Since commercially available progressive distributors sometimes have more than two output connections, a minimum of two hydraulic cylinders may, for example, be controlled in semi-synchronized operation with four outputs.

By connecting the hydraulic cylinders to the distribution device to the pressure supply via check valves or shut-off valves in the bypass, the hydraulic cylinders may be returned to their initial position in a simple and rapid manner when the hydraulic pressure is relieved. The parallel synchronized adjustment of the hydraulic cylinders may then be begun again via the progressive distributor.

By designing the distribution device as a hydraulic progressive distributor with at least two distribution pistons in a sequence control circuit, the distribution pistons are secured against a simultaneous distribution movement by means of a mechanical or another adequate forced control, wherein a possibility for reversing the parallel synchronized adjustment is achieved by the distribution pistons, wherein the distribution pistons of the progressive distributor under pressure of the cylinders respectively define small amounts of fluid centrally to the pressure supply in the reverse principle from the hydraulic cylinders. The fluid is stored there, for example, in a tank or other suitable reservoir.

By limiting the stroke movement of the distribution pistons of the hydraulic progressive distributor with variable or adjustable end stops, different defined fluid quantities may be allocated to the individual hydraulic cylinders. As a result, a different transmission ratio of the individual cylinder strokes relative to each other or a synchronization of cylinders with different piston diameters, may be achieved.

If the distribution device between the pressure supply and the hydraulic cylinders is at least partially formed as a cascade comprising several progressive distributors, a plurality of hydraulic cylinders may be controlled according to the invention. By connecting a further progressive distributor to the output of a first progressive distributor, the distributor outputs may be multiplied. A correspondingly high number of hydraulic cylinders may thus be connected. A symmetrical arrangement of the cascade or series circuit of distributors is recommended.

By using at least two of the hydraulic cylinders, which are designed as double-acting hydraulic cylinders and are connected to a pressure supply in such a way that at least the piston crown sides or the piston ring sides of the hydraulic cylinders are connected to a distribution device, a double-acting constrained movement of the hydraulic positioning device according to the invention is obtained.

If the hydraulic cylinders, which are designed as double-acting hydraulic cylinders, are provided on the piston crown side and/or the piston ring side with an end position valve which hydraulically connects the piston crown side and the piston ring side in an end position of the hydraulic cylinder, in the event of leaks occurring after the approach to an end position of the adjusting device, an automatic end position adjustment automatically compensates between the hydraulic cylinders until all the cylinders have reached their end position.

In a particularly safe embodiment according to the invention, the piston crown sides and/or the piston ring sides of the double-acting hydraulic cylinder are connected via a distribution device or directly to a pressure supply, wherein at least one unlockable check valve is arranged between at least one cylinder and the distribution device and/or the pressure supply. By means of this circuit arrangement, even in the event of unforeseen loads on the hydraulic cylinders or sudden pressure drops, a defined and controlled movement of the adjusting device or a safe state is always ensured. Unintentional cylinder movements, as occur, for example, in the event of cylinder cavitation, are hereby effectively avoided.

By designing at least one hydraulic cylinder as a memory cylinder with a floating piston or as a double cylinder with a common piston rod, the hydraulic cylinder may perform two adjusting movements independently of one another, for example a positioning movement according to the invention and a further stroke movement from a working position to a transport position independently of the latter.

By providing at least one hydraulic cylinder with a displacement measuring system which is connected to a display, control or regulating device, the positioning device according to the invention may be monitored or the positioning movement may be fed back to a control or regulating circuit as an input variable.

If at least one distribution piston of a progressive distributor is provided with a movement measuring system which is connected to or forms a counter, a display, control or regulating device, the detected or measured stroke of at least one distribution piston may be used to determine the displaced fluid volume of the progressive distributor. This fluid volume, as an absolute value or over time, also forms a measure for the adjustment path or the adjustment speed of the device according to the invention.

In particular, the proposed positioning device has proven itself in an agricultural device for a segment-wise pressure or depth adjustment of the working, spreading or depth guidance devices or the folding device of such a device. In this case, for example, may be mentioned the parallel control of pressure or packer rollers distributed over the device width, transport wheels, sowing or loosening shears, as well as the sequential or symmetrical folding of a machine frame or a distribution boom, which is effected using single or double-acting hydraulic cylinders.

When the positioning device according to the invention is used in a plow for parallel cutting width adjustment of a plurality of plow bodies, which are arranged to be pivotable relative to the plow frame, wherein the plow bodies are supported relative to the frame by means of hydraulic cylinders, mechanical coupling of the plow bodies to obtain synchronization may be dispensed with. With a suitable selection of further appropriately dimensioned hydraulic cylinders to adjust the front furrow width or the pull point of the plow, these may also be connected to the distribution device. By selecting or combining different conveying volumes of the distribution device for the hydraulic cylinders for the adjustment of the plow body and the other hydraulic cylinders, different transmission ratios between these cylinders may be set or selected as required for exact plow adjustment.

The invention is distinguished in particular by the fact that the use of cost-effective progressive distributors may be used to interconnect a plurality of hydraulic cylinders to form a synchronized assembly. By means of this form of circuit, a forced synchronized or semi-synchronized operation of the hydraulic cylinders is achieved. In this case, the cylinder movement takes place in small increments, independent of the forces acting on the cylinders or generated by these cylinders. By using or combining different dispensing volumes of a progressive distributor, different transmission ratios may also be set between the individual hydraulic cylinders. In particular, the simple detection of the distribution piston movement of a progressive distributor allows, in addition, a simple, but sufficiently precise determination of the individual travel of the hydraulic cylinders.

Further details and advantages of the subject matter of the invention may be gathered from the following description and the associated drawings, in which an exemplary embodiment with the necessary details and individual parts is shown:

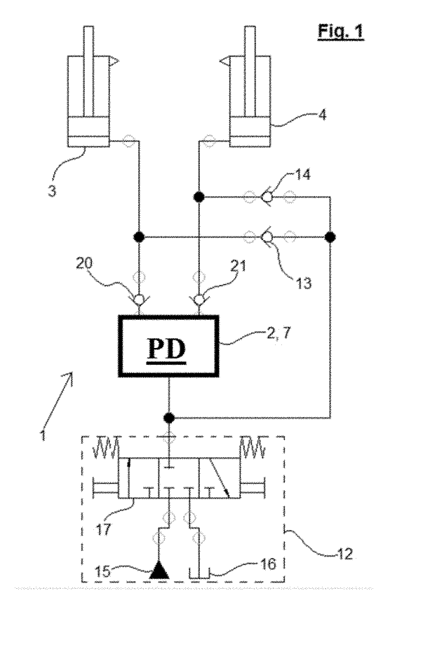

FIG. 1 shows a synchronization circuit of two hydraulic cylinders according to the invention,

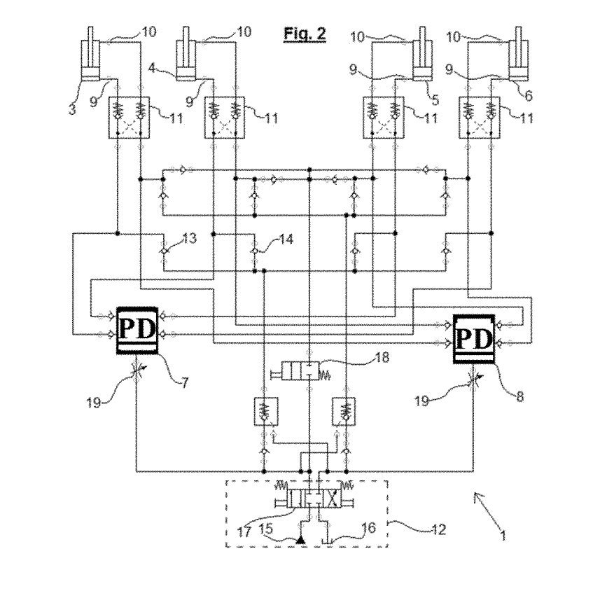

FIG. 2 shows a synchronization circuit of several double-acting hydraulic cylinders according to the invention, and

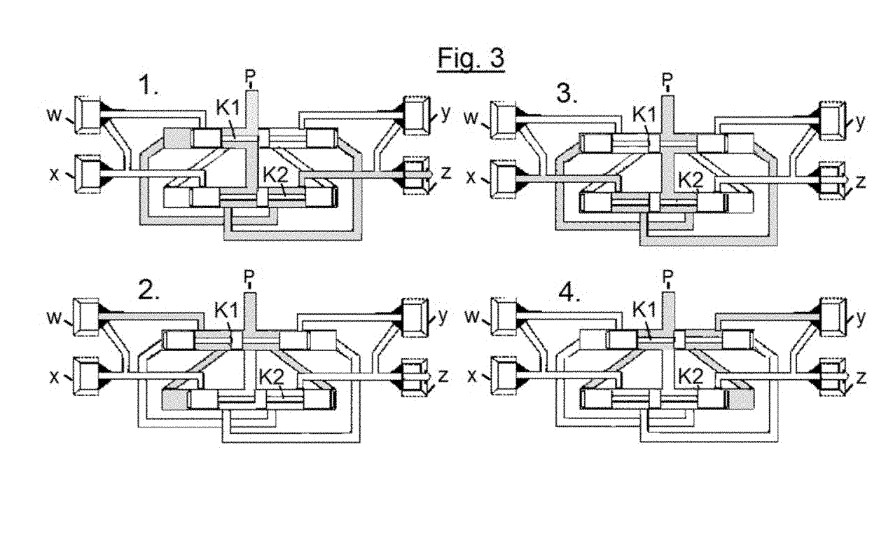

FIG. 3 shows a simplified schematic of a progressive distributor in 4 views.

FIG. 1 describes the basic design of a circuit according to the invention of the positioning device 1. The supply and return of a pressurized fluid, preferably hydraulic oil, takes place via the pressurized supply 12. The pressure supply is thus part of a tractor, while the remaining circuit components are part of an agricultural device. The pressure supply 12 consists of a pump 15, a tank 16 or a suitable reservoir, as well as a multi-path valve 17 for controlling the pressurized fluid flow. The pressure supply 12 or its components may be assigned to a tractor, but also to the device and even have its own independent power supply. If the valve slide of the multi-path valve 17 in FIG. 1 is moved to the right from the depicted neutral middle position, there is a fluid flow into the inlet of a distribution device 2, which is shown here as a single progressive distributor 7. If, for example, the progressive distributor 7 has four outputs, two outputs are respectively connected to a single-acting hydraulic cylinder 3, 4. Likewise, the displacement chambers of the distribution pistons of the progressive distributor 7 may be interconnected internally, so that, for example, there are only two outputs from the progressive distributor 7. Optionally, the outputs of the progressive distributor 7 are provided with check valves 20, 21 for their relief. The distribution pistons of the progressive distributor 7 move forcibly one after the other under the pressure of the fluid flow and displace a small defined quantity of fluid alternately and successively into the outputs and the connected left hydraulic cylinder 3 or right hydraulic cylinder 4. According to the allocated fluid volume, the two hydraulic cylinders 3, 4 alternately travel in small steps. This results in a load-independent synchronized connection of the two hydraulic cylinders 3, 4 whose stepwise movement causes only negligibly small inaccuracies in the synchronization. If the valve slide of the multi-path valve 17 is moved into the opposite left position, the hydraulic fluid may flow back into the oil tank 16 of the pressure supply 12 under the load of the hydraulic cylinders through the two check valves 13 or 14. If the progressive distributor is not self-blocking in the opposite flow direction, the hydraulic fluid may also flow through the progressive distributor in the reverse order of movement of the distribution pistons. The check valves 13 and 14 as well as 20 and 21 are then superfluous. In this case, the progressive distributor produces a double-acting or reversed synchronization of the hydraulic cylinders 3, 4 in both positioning directions.

FIG. 1 shows just one example of a circuit according to the invention. Depending on the number of outputs of the progressive distributor, more hydraulic cylinders than represented may be connected or combined. Likewise, several progressive distributors may be connected in parallel, or cascaded in series. As a result, the connection possibilities for a multiplicity of hydraulic cylinders are increased or multiplied. Also, some outputs of the progressive distributor may be connected unused to the tank 16 via a return line. The synchronization of the hydraulic cylinders, which are connected to the remaining outputs of the progressive distributor, is thus maintained. For the basic operation of a progressive distributor, in particular the movement of its distribution pistons and their sequence control circuit, reference should be made to the above-cited prior art as well as to the description of FIG. 3. With a flow limiter, which is connected between the pressure supply 12 and the distribution device 2, the actuating speed of the device may be regulated and the distribution device may be protected against overloading. A simple throttle valve is sufficient here, for example.

FIG. 2 shows the schematic construction of a positioning device 1 with four double-acting hydraulic cylinders 3, 4, 5, 6, which are each provided with stop valves or hydraulically unlockable check valves 11 for securing and preventing uncontrolled movements, for example in the case of pressure loss. The unlockable check valves 11 may be integrated in the hydraulic cylinders or arranged separately. The pressure supply 12 is designed as described above in FIG. 1, but is provided with a double-acting multi-path valve 17. If the valve slide of the multi-path valve 17 is shifted to the right in the illustrated circuit diagram, hydraulic fluid flows under pressure from the pump 15 to the first progressive distributor 7. The fluid flow is thereby limited by a throttle valve or another, preferably adjustable flow limiter 19. The progressive distributor 7 is provided with four outputs, wherein one output is respectively operatively connected to a piston crown side 9 of the respective cylinder 3, 4, 5, 6. As a result of the forced movement of the distributor pistons within the progressive distributor 7, the hydraulic cylinders 3, 4, 5, 6 travel successively in small path increments, starting from cylinder 3 to cylinder 6. Thereafter, cylinders 3 etc. are moved again until the extended end position of the hydraulic cylinders is reached. In this case, each stop valve 11, which is connected to the hydraulic cylinders 3 to 6, releases the piston ring side 10 of the respective cylinders 3, 4, 5, 6 as long as it is pressurized by an output of the progressive distributor. The hydraulic fluid displaced on the piston ring side flows back into the tank 16 of the pressure supply 12 via several lines, which are interlocked with one another by check valves 13, 14. For the sake of clarity, only two of the illustrated check valves 13, 14 are provided with reference symbols. If the multi-path valve 17 is moved back into the middle neutral position, all four cylinders remain in a secure, blocked state through the upstream stop valve 11. If the valve slide of the multi-path valve 17 is moved into the opposite left position, hydraulic fluid flows from the pump 15 into the right-hand progressive distributor 8. The progressive distributor 8 is connected to the respective piston ring sides 10 of the hydraulic cylinders 3, 4, 5, 6. In a precisely opposite manner, as described above, the hydraulic cylinders now move incrementally one after the other until they reach the retracted end position. When a gate valve 18 is actuated, which is closed in regular operation, the cylinders 3, 4, 5, 6 may be driven back into a defined initial position in the event of small leaks occurring.

FIG. 3 shows the fluid course through a progressive distributor in four views. Starting from the inlet P, the fluid is forcibly and successively distributed in equal amounts to the outlets w, x, y, z by means of the distribution pistons K1 and K2. It is assumed that the progressive distributor is already filled in all channels.

In the first view of FIG. 3, the fluid passes under pressure from inlet P to the right side behind the distribution piston K1 and pushes it to the left. The fluid displaced on the left side of the piston is discharged via outlet z. In the next step in the second view, the fluid flows under pressure from inlet P to the right side behind the distribution piston K2 and likewise pushes it to the left. The fluid displaced on the left side of the piston is discharged via outlet w.

In the third step in the third view, the fluid flows under pressure from inlet P to the left side behind the distribution piston K1 and pushes it to the right. The fluid displaced on the right side of the piston is discharged via outlet x. In the final step of the sequence control circuit in the fourth view, the fluid flows under pressure from inlet P to the left side behind the distribution piston K2 and likewise pushes it to the right. The fluid displaced on the right side of the piston is discharged via outlet y. Next, the process starts from the front, as previously described for the first view of FIG. 3 and the subsequent views 2 to 4. The outputs w and x as well as y and z are connected in parallel with each other via a closable bypass. In this way, two hydraulic cylinders may be actuated in synchronization. If the bypass is closed, four hydraulic cylinders may be actuated in synchronization. When the fluid flow of an outlet is returned into the tank, three cylinders may be actuated in synchronization. Further distribution piston segments may also be added. Accordingly, the number of possible outputs increases in pairs.

If the process is reversed by fluid pressure being applied to the outlet connections w, x, y, z, and the inlet P is reversed, fluid flows through the connection x behind the right side of the distribution piston K1 from the fourth view in FIG. 3. This moves to the left and displaces the fluid to the left of the piston into inlet P. Next, connection w is applied in the third view and pushes the lower distribution piston K2 to the right. The right-hand fluid volume of the distribution piston K2 is also displaced in the inlet P. In the second view, connection z and distribution piston K1 and, in the first view, connection y and distribution piston K2 are acted upon and displace the fluid analogously into the inlet P. The other pressurized outputs are interlocked by the respective piston position and fluid channels The resulting piston forces are canceled. As described at the outset, only the principle fluid flow is shown. If the two pistons are locked by means of hydraulic, mechanical or suitable devices, so that they do not move simultaneously, an operationally safe and optionally reversible force distribution system is obtained.

### LIST OF REFERENCE NUMERALS/SYMBOLS

| | |
|---|---|
| 1 | Hydraulic positioning device |
| 2 | Distribution device |
| 3 | Hydraulic cylinder |
| 4 | Hydraulic cylinder |
| 5 | Hydraulic cylinder |
| 6 | Hydraulic cylinder |
| 7 | Progressive distributor |
| 8 | Progressive distributor |
| 9 | Piston crown side |
| 10 | Piston ring side |
| 11 | Unlockable check valve, stop valve |
| 12 | Pressure supply |
| 13 | Check valve |
| 14 | Check valve |
| 15 | Pump |
| 16 | Tank, reservoir |
| 17 | Multi-path valve |
| 18 | Gate valve |
| 19 | Flow limiter |
| 20 | Check valve |
| 21 | Check valve |
| K1 | Distribution piston |
| K2 | Distribution piston |
| P | Input connection progressive distributor |
| w | Output connection progressive distributor |
| y | Output connection progressive distributor |
| x | Output connection progressive distributor |
| z | Output connection progressive distributor |

1. Hydraulic positioning device (1), in particular for use as a positioning system of an agricultural machine, comprising at least one controllable or regulatable pressure supply (12) and at least one distribution device (2) connected thereto, wherein at least a first and a second hydraulic cylinder (3, 4) are in hydraulic connection with the distribution device,
characterized in that
the distribution device (2) is designed as a hydraulic progressive distributor (7, 8) which, by means of at least two distribution pistons (K1, K2), arranged in a downstream circuit, feed the fluid flow of the pressure supply (12) to the hydraulic cylinders in defined amounts (3, 4).

2. Positioning device according to claim 1,
characterized in that
at least two connections (w, x) of the distribution device (2) are connected to one another and to a hydraulic cylinder (3, 4) in a parallel circuit.

3. Positioning device according to claim 1,
characterized in that
the hydraulic cylinders (3, 4) are connected to the pressure medium supply (12) via check valves (13, 14) or shut-off valves in the bypass to the distribution device (2).

4. Positioning device according to claim 1,
characterized in that
the distribution device (2) is designed as a hydraulic progressive distributor (7, 8) with at least two distribution pistons (K1, K2) in a sequence control circuit, wherein the distribution pistons (K1, K2) are secured by a mechanical forcing control against a simultaneous distribution movement.

5. Positioning device according to claim 1,
characterized in that
the distribution pistons (K1, K2) of the hydraulic progressive distributor (7, 8) with variable or adjustable end stops are limited in their stroke movement.

6. Positioning device according to claim 1,
characterized in that
the distribution device (2) is at least partially formed as a cascade of several progressive distributors (7, 8) between the pressure supply (12) and the hydraulic cylinders (3, 4).

7. Positioning device according to claim 1,
characterized in that
at least two of the hydraulic cylinders (3, 4) are designed as double-acting hydraulic cylinders and are connected to a pressurized medium supply (12), wherein at least the piston crown sides (9) or the piston ring sides (10) of the hydraulic cylinders (3, 4) are connected to a distribution device (2).

8. Positioning device according claim 7,
characterized in that
the hydraulic cylinders (3, 4) are provided as double-acting hydraulic cylinders on the piston crown side (9) and/or the piston ring side (10) with an end position valve which hydraulically connects the piston crown side (9) and the piston ring side (10) together.

9. Positioning device according to claim 8,
characterized in that
the piston crown sides (9) and/or the piston ring sides (10) of the double-acting hydraulic cylinders (3, 4) are connected via a distribution device (2) or directly to a pressure supply (12), wherein at least one check valve (11) is arranged between at least one cylinder (3, 4, 5, 6) and the distribution device (2) and/or the pressure supply (12).

10. Positioning device according to claim 9,
characterized in that
at least one hydraulic cylinder (3, 4, 5, 6) is provided as a memory cylinder or as a double cylinder with a common piston rod.

11. Positioning device according to claim 9,
characterized in that
at least one hydraulic cylinder (3, 4, 5, 6) is equipped with a displacement measuring system which is connected to a display, control or regulating device.

12. Positioning device according to claim 1,
characterized in that
at least one distributor piston (K1, K2) of a progressive distributor (7, 8) is provided with a movement measuring system which is connected to a counter, a display, control or regulating device.

13. Agricultural implement with a positioning device according to claim 1,
characterized in that
the positioning device (1) of a segment-wise pressure or depth adjustment of the working, dispensing or depth-guiding devices or of the folding device is assigned to such a device.

14. Plow with a positioning device claim 1,
characterized in that
the positioning device (1) is used for the parallel cutting width adjustment of a plurality of plow bodies, which are arranged to be pivotable relative to the plow frame, wherein the plow bodies are supported on the frame by means of the hydraulic cylinders.
